(19) United States
(12) Patent Application Publication
(10) Pub. No.: US 2016/0016233 A1
(43) Pub. Date: Jan. 21, 2016

(54) NOTCHED CUTTING INSERTS AND APPLICATIONS THEREOF

(71) Applicant: Kennametal India Limited, Bangalore (IN)

(72) Inventor: Prasanna SANJEEVASETTY, Bangalore (IN)

(21) Appl. No.: 14/800,443

(22) Filed: Jul. 15, 2015

(30) Foreign Application Priority Data
Jul. 17, 2014 (IN) 3520CHE2014

(51) Int. Cl. B23B 27/16

(52) U.S. Cl. CPC B23B 27/164; B23B 2200/0452; B23B 2200/088; B23B 2200/165

(57) ABSTRACT

In one aspect, cutting inserts are described herein comprising a notched architecture for facile and accurate securement to a tool holder. A cutting insert described herein comprises a top surface, a bottom surface and side surfaces extending between the top and bottom surfaces, the cutting insert having a first axis bisecting a nose of the cutting insert and a notch in the top surface, the notch arranged normal to the first axis.

### RELATED APPLICATION DATA

The present application claims priority pursuant to 35 U.S.C. §119(a) to Indian Patent Application Number 3520CHE2014 filed Jul. 17, 2014, which is hereby incorporated by reference in its entirety.

### FIELD

The present invention relates to cutting inserts and, in particular, to cutting inserts employing one or more notches for securement in a tool holder.

### BACKGROUND

Cutting inserts of various geometries for use with many types of cutting tools in machining operations are generally known. Such cutting inserts are usually indexable and replaceable, permitting efficiencies to be realized in large-scale cutting operations. The use of replaceable indexed inserts, for example, allows for rapid changing of the inserts upon substantial cutting edge wear. Further, various insert geometries enable use of a single tooling apparatus across several different machining operations.

To realize the foregoing efficiencies, indexable inserts must be accurately and securely placed in the tool holder. Various mechanisms have been developed for securing cutting inserts in tool holder pockets. Cutting inserts, for example, can be provided a central hole for receiving a securing pin. In such embodiments, the cutting insert has sufficient surface area to preclude compromises to insert structural integrity induced by central hole incorporation. Alternatively, cutting inserts may be secured by clamping apparatus. Several examples of clamping apparatus are described in U.S. Pat. Nos. 3,754,309 and 4,834,592. As noted in these patent documents, the cutting inserts are restricted to grooving and threading operations and lack sufficient surface area for fastening via a central hole configuration. Cutting tool design continues to evolve in response to the changing demands of cutting applications, thereby calling for the development of new cutting insert architectures and associated fastening configurations.

### SUMMARY

In one aspect, cutting inserts are described herein comprising a notched architecture for facile and accurate securement to a tool holder. For example, a cutting insert described herein comprises a top surface, a bottom surface and side surfaces extending between the top and bottom surfaces, the cutting insert having a first axis bisecting a nose of the cutting insert and a notch in the top surface, the notch arranged normal to the first axis. The cutting insert can further comprise a second axis normal to the first axis, wherein the notch extends the entire length of the second axis. In some embodiments, surfaces of the cutting insert transitioning from the notch to the top surface are curved. Additionally, in some embodiments, the cutting insert further comprises a notch in the bottom surface, the bottom notch also arranged normal to the first axis. The bottom notch can be positioned in the bottom surface to mirror the notch placement in the top surface. In such embodiments, a horizontal plane of symmetry can exist between the top surface and bottom surface notches.

In another aspect, cutting tools are described herein. In some embodiments, a cutting tool described herein comprises a tool holder including a pocket and a cutting insert positioned in the pocket, the cutting insert comprising a top surface and a bottom surface and side surfaces extending between the top and bottom surfaces. The cutting insert has a first axis bisecting a nose of the cutting insert and a notch in the top surface, the notch arranged normal to the first axis. A clamp engages the notch in the top surface fixing the cutting insert in the pocket. The pocket comprises side surfaces for engaging side surfaces of the cutting insert. In some embodiments, the bottom surface of the cutting insert engages the bottom surface of the pocket. Alternatively, a seat may be positioned between the cutting insert and the bottom surface of the pocket.

These and other embodiments are described in greater detail in the detailed description which follows.

### BRIEF DESCRIPTION OF THE DRAWINGS

FIG. 1 illustrates a perspective view of a cutting insert according to one embodiment described herein.

FIG. 2 illustrates a top plan view of a cutting insert according to one embodiment described herein.

FIG. 3 illustrates a sectional elevational view of a notch in the top surface of a cutting insert according to one embodiment described herein.

FIG. 4 illustrates an elevational view of a cutting insert according to one embodiment described herein.

FIG. 5 illustrates an exploded view of cutting tool described herein.

FIG. 6 illustrates a top plan view of a cutting tool according to one embodiment described herein.

FIG. 7 illustrates an elevational view of a cutting tool according to one embodiment described herein.

### DETAILED DESCRIPTION

Embodiments described herein can be understood more readily by reference to the following detailed description and examples and their previous and following descriptions. Elements and apparatus described herein, however, are not limited to the specific embodiments presented in the detailed description. It should be recognized that these embodiments are merely illustrative of the principles of the present invention. Numerous modifications and adaptations will be readily apparent to those of skill in the art without departing from the spirit and scope of the invention.

### I. Notched Cutting Insert

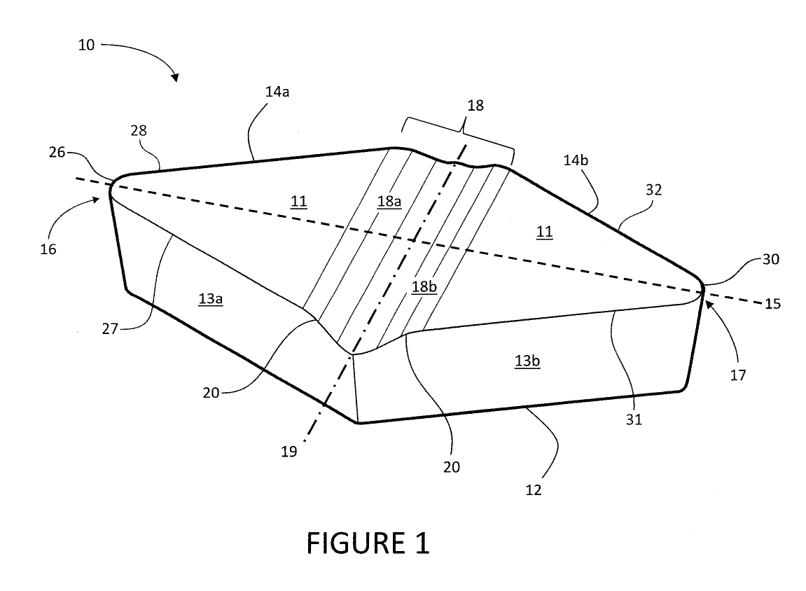

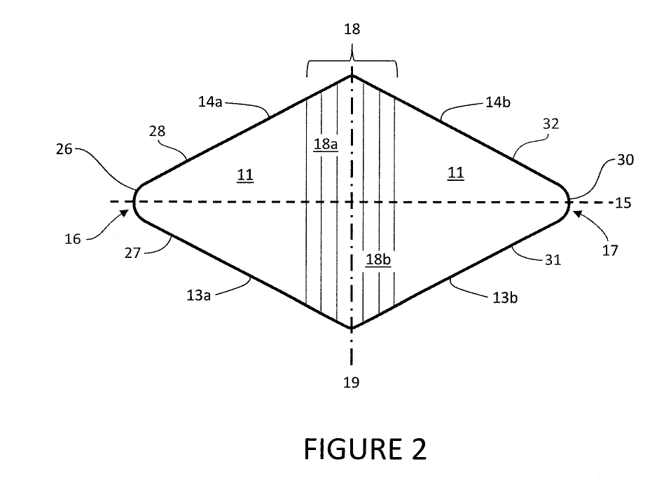

Referring now to FIGS. 1-3, there is illustrated a cutting insert, generally designated as reference number 10, in accordance with several embodiments described herein. As provided in FIG. 1, the cutting insert comprises a top surface (11), a bottom surface (12) and side surfaces (13a, 13b, 14a, 14b) extending between the top (11) and bottom (12) surfaces. A first axis (15) bisects a nose (16) of the cutting insert (10). In the embodiment illustrated in FIG. 1, the cutting insert (10) displays a rhomboid geometry where the first axis (15) also bisects the second nose (17) of the insert (10). A notch (18) is positioned in the top surface (11) and arranged normal to the first axis (15). The cutting insert (10) includes a second axis (19) normal to the first axis (15). In some embodiments, as illustrated in FIGS. 1 and 2, the notch (18) extends the entire length of the second axis (19).

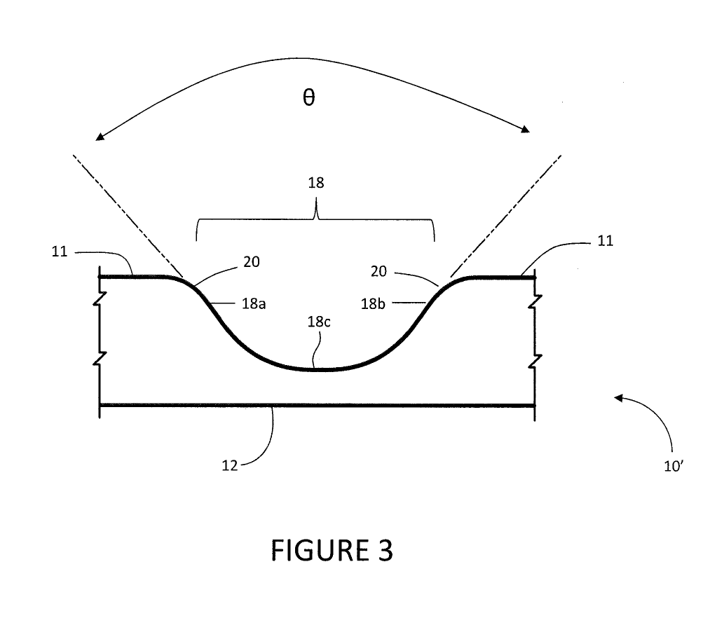

The notch can be of any shape not inconsistent with the objectives of the present invention. In the embodiments of FIGS. 1-3, the notch (18) is generally V-shaped. In other embodiments, the notch can be generally U-shaped. Further, the notch (18) can display several curved surfaces as opposed to sharp transitions between sides (18a, 18b) of the notch (18) and the top surface (11). As provided in FIG. 3, surfaces (20) transitioning from the notch (18) to the first surface (11) are curved. Additionally, sides (18a, 18b) of the notch (18) are joined by a curved bottom surface (18c).

Sides (18a, 18b) of the notch (18) can be of any desired length not inconsistent with the objectives of the present invention. In some embodiments, for example, sides (18a, 18b) have a length of 1-2 mm, such as 1.5-1.9 mm. Moreover, sides (18a, 18b) can be of the same length or substantially the same length or of different length. As illustrated in FIG. 3, sides (18a, 18b) of the notch (18) can be arranged relative to one another, forming any desired angle, θ. In some embodiments, for example, sides (18a, 18b) are arranged to provide θ in the range of 110° to 130°, such as 115° to 125°. Additionally, the notch (18) can have any depth into the body of the cutting insert not inconsistent with the objectives of the present invention. For example, in some embodiments, the notch (18) has a depth of 0.5 mm to 1.5 mm. In another embodiment, the notch (18) has a depth of 0.9 mm to 1.1 mm. In certain embodiments, the notch (18) can have a depth of 10% to 70% of the thickness of the cutting insert (10). For example, the notch (18) can have a depth of 10% to 50%, 20% to 50%, 30% to 60%, or 10% to 40% of the thickness of the insert.

As illustrated in FIGS. 1 and 2 herein, the notch (18) can be positioned in the top surface along at least one vertical plane of symmetry of the cutting insert (10). In the embodiment of FIGS. 1 and 2, the second axis (19) is a vertical plane of symmetry and the notch (18) is centered and runs along this vertical plane of symmetry. The notch (18) can also be positioned normal to at least one vertical plane of symmetry of the cutting insert (10). In FIGS. 1 and 2, the first axis (15) serves a vertical plane of symmetry normal to the notch (18). It is contemplated herein that vertical planes of symmetry are established with reference to the perimeter shape of the cutting insert, wherein surface structures including chip breaker(s), support structure(s), abutment surface(s), ridges and other structures are not considered in the symmetry analysis.

Cutting edges of the insert (10) are formed at the intersection of the side surfaces (13a, 13b, 14a, 14b) with the top surface (11) and/or bottom surface (12). In the embodiment of FIGS. 1 and 2, the first cutting edge comprises a nose edge (26) and two main edges (27, 28) converging toward the nose edge (26). The nose edge (26) and the two main edges (27, 28) are formed by intersection of side surfaces (13a, 14a) with the top surface (11). Similarly, the cutting insert (10) comprises a second cutting edge comprising a nose edge (30) and two main edges (31, 32) converging toward the nose edge (30). As with the first cutting edge (26), the nose edge (30) and the two main edges (31, 32) of the second cutting edge are formed by intersection of side surfaces (13b, 14b) with the top surface (11). For negative rake inserts, the bottom surface (12) of the insert (10) forms two additional cutting edges with side surfaces (13a, 13b, 14a, 14b) in a manner consistent with that described for the top surface (12).

Nose edges (26, 30) of the cutting insert can have any desired radius. Additionally, the cutting insert (10) can have any desired included nose angle. In some embodiments, the cutting insert has an included nose angle in the range of 35 degrees to 90 degrees. Cutting inserts described herein, for example, can have ISO/ANSI geometries and designations. Accordingly, a cutting insert can have an included nose angle and geometry selected from Table I.

TABLE I
Cutting Insert Included Nose Angle and Geometry

| Included Nose Angle | Geometry | ISO/ANSI Code |
|---|---|---|
| 90 | Square | S |
| 90 | Rectangular | L |
| 80 | Rhomboid | C |
| 55 | Rhomboid | D |
| 75 | Rhomboid | E |
| 86 | Rhomboid | M |
| 35 | Rhomboid | V |
| 85 | Parallelogram | A |
| 82 | Parallelogram | B |
| 55 | Parallelogram | N/K |

Additionally, a cutting insert can exhibit a clearance angle or have no clearance. Suitable clearance angles can range from 3 degrees to 30 degrees as set forth in the ISO/ANSI designations. Cutting inserts described herein can be suitable for any desired cutting application. In some embodiments, the cutting inserts are employed in turning applications.

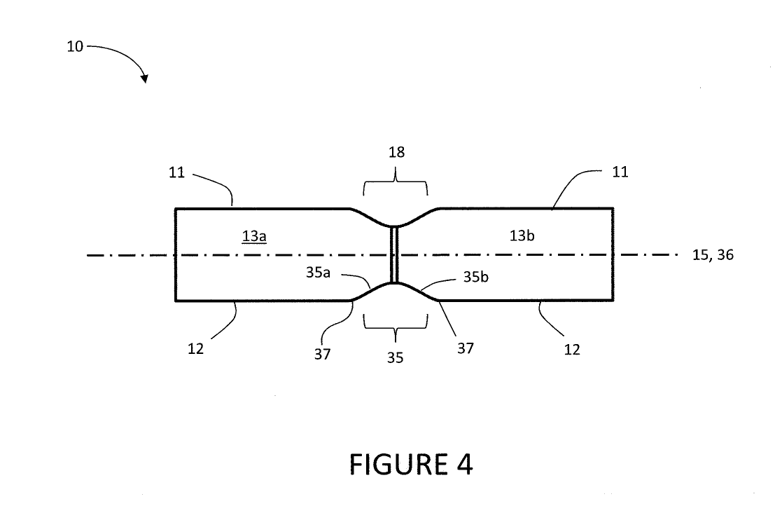

Referring now to FIG. 4, a cutting insert (10) described herein can further comprise a notch (35) in the bottom surface (12), wherein the bottom notch (35) is also arranged normal to the first axis (15). As illustrated in FIG. 4, the bottom notch (35) can be positioned in the bottom surface (12) to mirror the placement of the notch (18) in the top surface (11). In such embodiments, a horizontal plane of symmetry (36) can exist between the top and bottom surface notches (18, 35). The bottom surface notch (35) can have the same or substantially the same design and properties described in this Section I for the top surface notch (18). For example, the bottom surface notch (35) can be substantially V-shaped with surfaces (37) transitioning from the bottom notch (35) to the bottom surface (12) being curved. Further, the bottom notch (35) can have a depth of 0.5 mm to 1.5 mm with sides (35a, 35b) arranged relative to one another providing an angle θ′ of 110° to 130°.

Cutting inserts having architectures and properties described herein can be prepared by pressing and sintering operations. In some embodiments, the top surface notch (18) and, optionally, the bottom surface notch (35) can be formed in the pressing or green forming operation. Alternatively, the green cutting insert can be presintered or brown sintered and mechanically worked to provide the top surface notch (18) and, optionally, the bottom surface notch (35) in the insert. Once the top surface notch (18) and the optional bottom surface notch (35) are imparted to the cutting insert by green forming and/or mechanical working, the cutting insert is fully sintered to the appropriate density.

Cutting inserts described herein can be formed of various materials including cemented carbide, cermet, ceramics, sintered cubic boron nitride, sintered diamond, silicon nitride or SiAlON. Cemented carbide, in some embodiments, comprises tungsten carbide (WC). WC can be present in a cutting insert in an amount of at least about 80 weight percent or in an amount of at least about 85 weight percent. Additionally, metallic binder of cemented carbide can comprise cobalt or cobalt alloy. Cobalt, for example, can be present in a cemented carbide insert in an amount ranging from 3 weight percent to 15 weight percent. In some embodiments, cobalt is present in an amount ranging from 5-12 weight percent or from 6-10 weight percent. Further, a cemented carbide insert may exhibit a zone of binder enrichment beginning at and extending inwardly from the surface of the substrate.

### II. Cutting Tools

In another aspect, cutting tools are described herein. A cutting tool described herein comprises a tool holder including a pocket and a cutting insert positioned in the pocket, the cutting insert comprising a top surface and a bottom surface and side surfaces extending between the top and bottom surfaces. The cutting insert has a first axis bisecting a nose of the cutting insert and a notch in the top surface, the notch arranged normal to the first axis. A clamp engages the notch in the top surface fixing the cutting insert in the pocket.

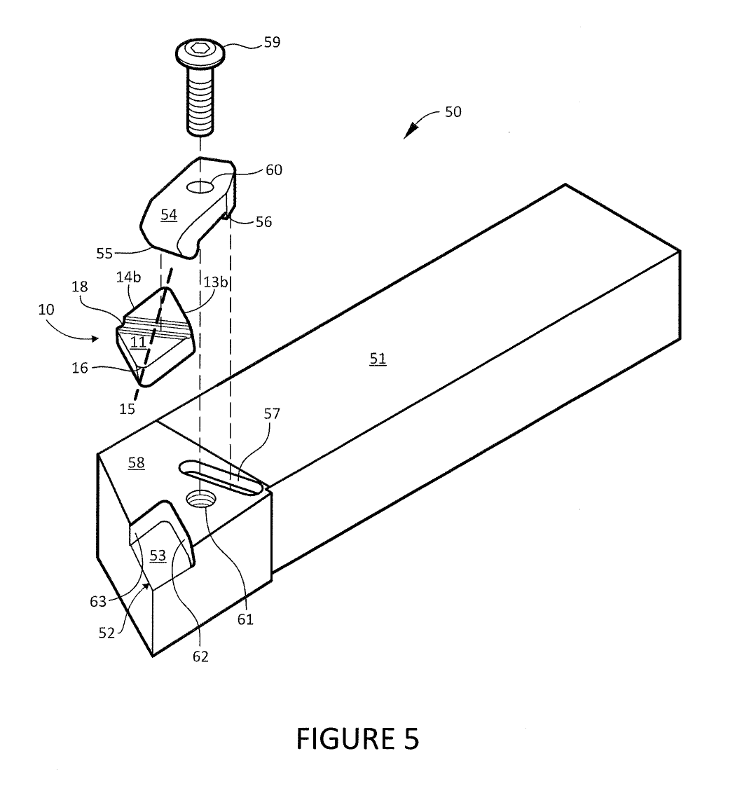

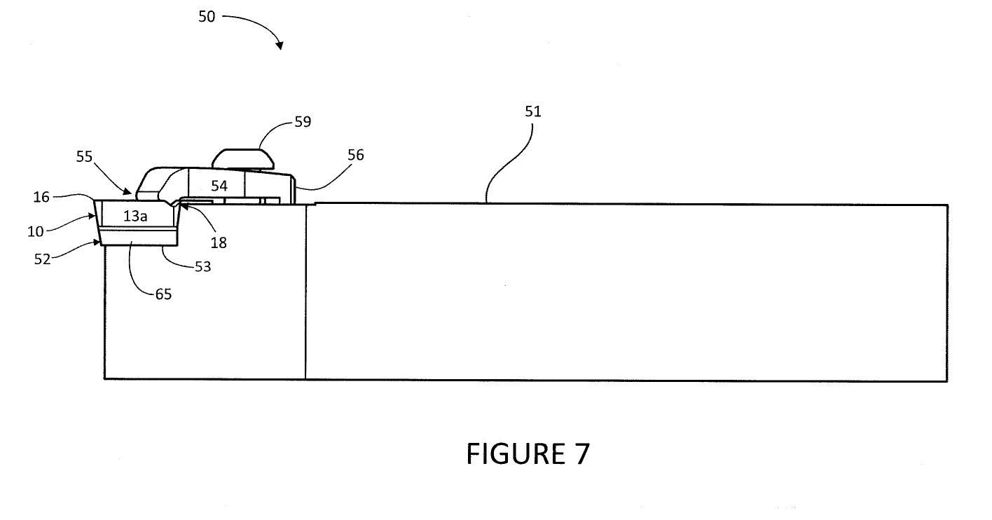

Referring now to FIGS. 5-7, there is illustrated a cutting tool, generally designated reference number (50), in accordance with several embodiments described herein. As illustrated in the exploded view of FIG. 5, the cutting tool (50) comprises a bar-like member (51) adapted to being coupled to any desired type of tool member. At one end of the bar-like member (51) resides a cutting insert pocket (52) having a bottom surface (53) and side surfaces (62, 63) for engaging the bottom surface (12) and side surfaces (13b, 14b) of the cutting insert (10). As illustrated in FIG. 7, an insert seat (65) can be arranged between the bottom surface (53) of the pocket (52) and the cutting insert (10). As described herein, the cutting insert (10) comprises a first axis (15) bisecting a nose (16) of the cutting insert (10) and a notch (18) in the first surface (11). The notch (18) is arranged normal to the first axis (15) and is generally a V-shape for receiving the nose (55) of a clamp (54). In some embodiments, the clamp nose (55) has a profile complimentary to the V-shaped notch (18). The clamp (54) further comprises a leg (56) adapted for being received in a recess (57) formed in a top surface (58) of the bar-like member (51). A clamp screw, bolt or pin (59) extends through a hole (60) in the clamp (54) and into a threaded hole (61) in the top surface (58) of the bar-like member (51).

When the cutting insert (10) is placed into the pocket (52), the clamp (54) put into position engaging the notch (18) and recess (57) and the screw (59) is inserted through the clamp hole (60) into the threaded hole (61) and tightened, the cutting insert (10) is pressed firmly against the bottom surface (53) of the pocket (52) while side surfaces (13b, 14b) are drawn toward and engage side surfaces (62, 63) of the pocket (52). Therefore, the cutting insert (10) is fixedly clamped in the pocket (52) of the tool holder (50) and is accurately located therein as guided by the engaging bottom surface (53) and side walls (62, 63) of the pocket (52). As described herein, an insert seat (65) can be positioned between the bottom surface (53) of the pocket (52) and the cutting insert bottom surface (12).

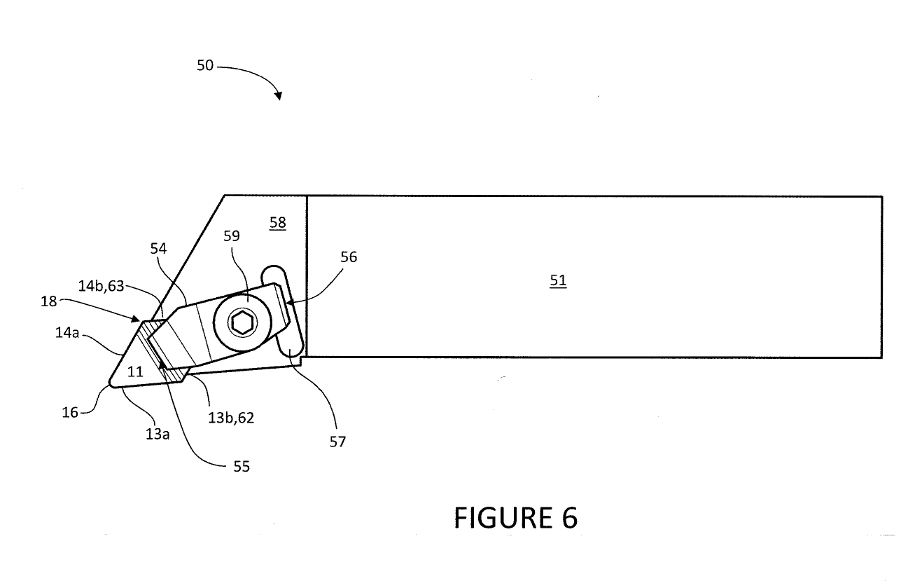

FIG. 6 illustrates a top plan view of the cutting tool (50) of FIG. 5 in assembled format. As provided in FIG. 6, the nose (55) of the clamp (54) engages the notch (18) in the top surface (11) of the cutting insert (10), securing the cutting insert (10) in the pocket (52) as described above. Similarly, FIG. 7 illustrates an elevational view of the cutting tool (50) of FIG. 5 in assembled format. In the view of FIG. 7, insert seat (65) is positioned between the bottom surface (53) of the pocket (52) and the cutting insert (10).

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A cutting insert comprising:
a top surface;
a bottom surface; and
side surfaces extending between the top and bottom surfaces, the cutting insert having a first axis bisecting a nose of the cutting insert and a notch in the top surface, the notch arranged normal to the first axis.

2. The cutting insert of claim 1, wherein the notch is substantially V-shaped.

3. The cutting insert of claim 2, wherein surfaces transitioning from the notch to the first surface are curved.

4. The cutting insert of claim 1, wherein sides of the notch converge into a curved base surface of the notch.

5. The cutting insert of claim 1, wherein sides of the notch are arranged relative to one another providing an angle θ in the range of 110° to 130°

6. The cutting insert of claim 1, wherein the cutting insert has a second axis normal to the first axis, the notch extending the entire length of the second axis.

7. The cutting insert of claim 1, wherein the notch is positioned in the top surface along a vertical plane of symmetry of the cutting insert.

8. The cutting insert of claim 1, wherein the notch extends into the cutting insert a depth of 0.5 mm to 1.5 mm.

9. The cutting insert of claim 1 having an included nose angle ranging from 35° to 90°.

10. The cutting insert of claim 9, wherein the cutting insert has an ISO geometry.

11. The cutting insert of claim 1 further comprising a notch in the bottom surface, the bottom notch arranged normal to the first axis.

12. The cutting insert of claim 11, wherein the bottom notch is substantially V-shaped.

13. The cutting insert of claim 12, wherein surfaces transitioning from the bottom notch to the bottom surface are curved.

14. The cutting insert of claim 11, wherein sides of the bottom notch are arranged relative to one another providing an angle θ′ in the range of 110° to 130°

15. The cutting insert of claim 1, wherein the bottom notch extends the entire length of the second axis.

16. The cutting insert of claim 11, wherein the bottom notch is positioned in the bottom surface to provide a horizontal plane of symmetry with the notch in the top surface.

17. The cutting insert of claim 1, wherein the bottom notch extends into the cutting insert a depth of 0.5 mm to 1.5 mm.

18. A cutting tool comprising:
a tool holder including a pocket for receiving a cutting insert;
a cutting insert positioned in the pocket, the cutting insert comprising a top surface and a bottom surface and side surfaces extending between the top and bottom surfaces, wherein the cutting insert has a first axis bisecting a nose of the cutting insert and a notch in the top surface, the notch arranged normal to the first axis; and
a clamp engaging the notch in the first surface fixing the cutting insert in the pocket.

19. The cutting tool of claim 18, wherein the clamp is fastened to the tool holder by one or more bolts or pins.

20. The cutting tool of claim 18, wherein the pocket comprises a bottom surface for engaging the bottom surface of the cutting insert and side surfaces for engaging the side surfaces of the cutting insert.

21. The cutting tool of claim 18, wherein the clamp comprises a curved surface for engaging the notch.

22. The cutting tool of claim 18, wherein side surfaces of the pocket are arranged to receive side surfaces at a nose of the cutting insert.

23. The cutting tool of claim 18, wherein the cutting insert has an included nose angle of 35 degrees to 90 degrees.

24. The cutting tool of claim 18, wherein surfaces of the cutting insert transitioning from the notch to the top surface are curved.

25. The cutting tool of claim 18, wherein sides of the notch are arranged relative to one another providing an angle θ in the range of 110° to 130°.

26. The cutting tool of claim 18, wherein the notch extends into the cutting insert a depth of 0.5 mm to 1.5 mm.

27. The cutting tool of claim 18, wherein cutting insert further comprises a notch in the bottom surface, the bottom notch arranged normal to the first axis.

28. The cutting tool of claim 27, wherein the bottom notch is positioned in the bottom surface to provide a horizontal plane of symmetry with the notch in the top surface.

29. The cutting tool of claim 27, wherein the bottom notch is substantially V-shaped.

30. The cutting insert of claim 29, wherein surfaces transitioning from the bottom notch to the bottom surface are curved.
